(19) United States
(12) Patent Application Publication
(10) Pub. No.: US 2014/0257952 A1
(43) Pub. Date: Sep. 11, 2014

(54) Methods and Systems for Administering Sweepstakes Contests

(71) Applicant: PRESTIGE GAMING, LLC, Anadarko, OK (US)

(72) Inventor: Chase Burns, Anadarko, OK (US)

(73) Assignee: Prestige Gaming, LLC, Anadarko, OK (US)

(21) Appl. No.: 13/789,957

(22) Filed: Mar. 8, 2013

(51) Int. Cl. G06Q 30/02

(52) U.S. Cl. CPC G06Q 30/0212
USPC 705/14.14

(57) ABSTRACT

Methods and systems for providing sweepstakes entries are disclosed. One disclosed method includes receiving a first transaction information from a first computing device over a network, comparing the first transaction information to a sweepstakes criteria using a sweepstakes engine to determine whether the transaction is sweepstakes eligible, allocating an available sweepstakes entry if the transaction is sweepstakes eligible, storing sweepstakes allocation information on a database server; generating sweepstakes entry information, and transmitting the sweepstakes entry information to a second computing device.

### FIELD OF THE INVENTION

The present invention generally relates to methods and systems for administering sweepstakes contests, and more particularly to methods and systems for awarding sweepstakes entries for eligible transactions.

### BACKGROUND

Sweepstakes contests are well-known tools for incentivizing product purchases and charitable donations. For example, sweepstakes contest pieces have been provided on fast food packaging, under soda bottle caps, and coupled with other consumer products to incentivize the purchase of those products. In addition, sweepstakes contests have long been used to generate proceeds for non-profit institutions such as charities and schools. Furthermore, the Internet has become a platform for administering sweepstakes contests. For example, Internet-based sweepstakes contests administered through websites, in addition to providing an electronic sweepstakes entry form, expose product advertising materials or information regarding a charity to potential customers/contributors. Some Internet-based sweepstakes contests allow a consumer to enter once per day, thereby maximizing consumers' exposure to the advertising materials.

In recent years, markets have emerged for virtual goods. In the realm of multiplayer online gaming, markets have emerged for sales of virtual products that aid advancement in the game and/or enhance the enjoyment of the game. For example, one popular multi-player poker application bankrolls new players with an initial amount of virtual poker chips. Players may then use the virtual poker chips to enter virtual poker tournaments or cash games to attempt to increase their total amount of virtual poker chips and rise up the player rankings. However, the popular multi-player poker application also offers for sale virtual poker chips to users who are willing to pay to get ahead in the player rankings rather than working their way up the rankings solely through playing poker. As used herein, virtual goods or products broadly refers to any item that is described as a physical item, but exists only in virtual or digital form, that are provided for collection, used as a currency (e.g. for the purchase other virtual products, physical products, services, or anything else that may be purchased, or for making charitable donations; referred to herein as “virtual currency”), or used as part of gameplay in a game or virtual application. Additional examples of virtual products are virtual weapons purchased in a game and that may be used to increase strength in battling against other players, virtual performance parts in a racing game, and virtual crops and livestock in a farming game.

In general, virtual products offered for sale for use in an application are both advertised and purchased within the application itself. While the purchase of virtual products may be incentivized by a user's desire to advance further in a game and/or increase enjoyment of playing the game, the sale of virtual products would be further incentivized by the award of sweepstakes entries for eligible purchases of virtual goods. Similarly, charitable donations made through applications are further incentivized by the award of sweepstakes entries for eligible donations.

### SUMMARY OF THE INVENTION

The present invention generally relates to a method comprising receiving a first transaction information from a first computing device over a network, comparing the first transaction information to a sweepstakes criteria using a sweepstakes engine to determine whether the transaction is sweepstakes eligible, allocating an available sweepstakes entry if the transaction is sweepstakes eligible, storing sweepstakes allocation information on a database server, generating sweepstakes entry information, and transmitting the sweepstakes entry information to a second computing device. Another embodiment comprises a computer-readable medium encoded with processor-executable software program code for carrying out such a method.

These illustrative embodiments are mentioned not to limit or define the invention, but to provide examples to aid understanding thereof. Illustrative embodiments are discussed in the Detailed Description and further description of the invention is provided therein. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying figures, wherein:

FIG. 1A is a block diagram illustrating a client device according to one embodiment of the present invention.

FIG. 1B is a block diagram illustrating a server according to one embodiment of the present invention.

FIG. 2 is a diagram illustrating a client-server network configuration according to one embodiment of the present invention.

FIG. 3 is a flow diagram illustrating the operation of a server in communication with a client device according to one embodiment of the present invention.

FIG. 4 is an illustrative interactive prize reveal screen according to one embodiment of the present invention.

FIG. 5 is an illustrative interactive prize reveal screen according to one embodiment of the present invention.

FIG. 6 is an illustrative interactive prize reveal screen according to one embodiment of the present invention.

FIG. 7 is an illustrative interactive prize reveal screen according to one embodiment of the present invention.

### DETAILED DESCRIPTION

Embodiments of the present invention provide methods and systems for administering sweepstakes contests. In one particular embodiment, sweepstakes entries are awarded for purchases of virtual products. In another embodiment, sweepstakes entries are awarded for charitable donations.

### Illustrative Method and System for Administering Sweepstakes

In one illustrative embodiment, a user of a client device having one or more installed applications, such as a touchscreen smartphone, makes a purchase or a charitable donation within an application (an “in-app purchase”). For example, a user downloads a virtual slot machine application from an application server to his smartphone. The virtual slot machine application requires virtual chips to play. When the user runs out of virtual chips, he may execute an in-app purchase of additional virtual chips so that he may continue to enjoy the virtual slot machine application. The smartphone communicates with an application server to complete the in-app purchase. Upon completion of the in-app purchase, the application server sends information relating to the in-app purchase to a server configured to administer sweepstakes contests (the “Sweepstakes Server”). The Sweepstakes Server receives and processes the information relating to the in-app purchase to determine whether the in-app purchase meets eligibility criteria for the award of one or more sweepstakes entries. If the Sweepstakes Server determines that the in-app purchase is eligible, then the Sweepstakes Servers selects an appropriate number of available sweepstakes entries from a finite predetermined pool of sweepstakes entries, removes the entries from the pool of entries, and allocates the selected sweepstakes entries to the in-app purchase and/or the sweepstakes contestant who made the in-app purchase. The Sweepstakes Server stores the allocation information in a database and generates sweepstakes entry information for transmission to the user's smartphone.

In the illustrative embodiment, the sweepstakes entry information comprises information about the prizes to be awarded to the user and an interactive interface for revealing the prizes to the user. For example, when the user's smartphone receives the sweepstakes entry information, it may display an interactive prize reveal interface that resembles a scratch-off lottery ticket. The user may drag a finger back and forth over the interface as if moving a coin back and forth to reveal the results of a scratch-off lottery ticket in order to reveals the awarded sweepstakes prizes. This illustrative embodiment is merely an example, and embodiments of the present invention are not limited to this illustrative embodiment.

### Exemplary System Components

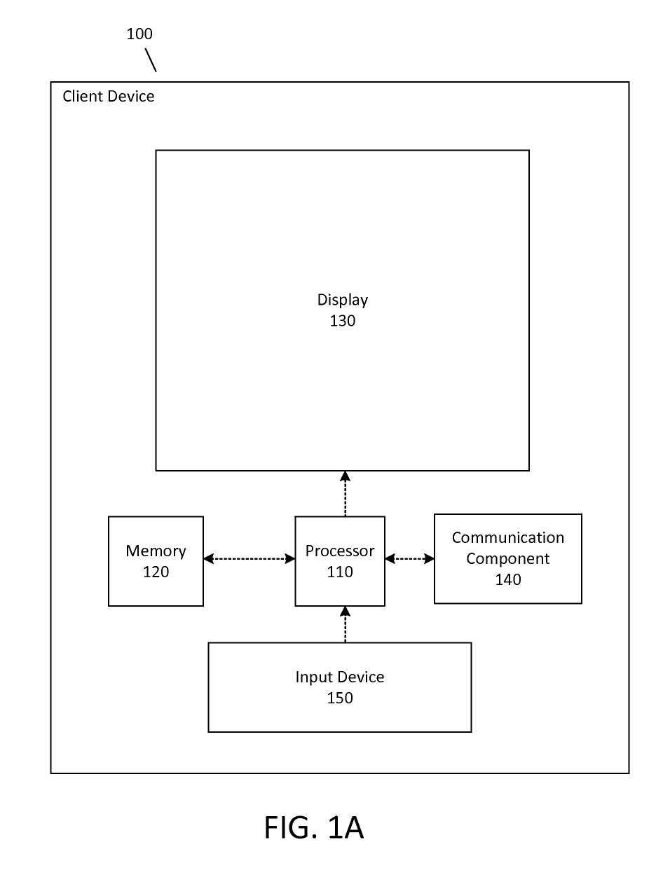

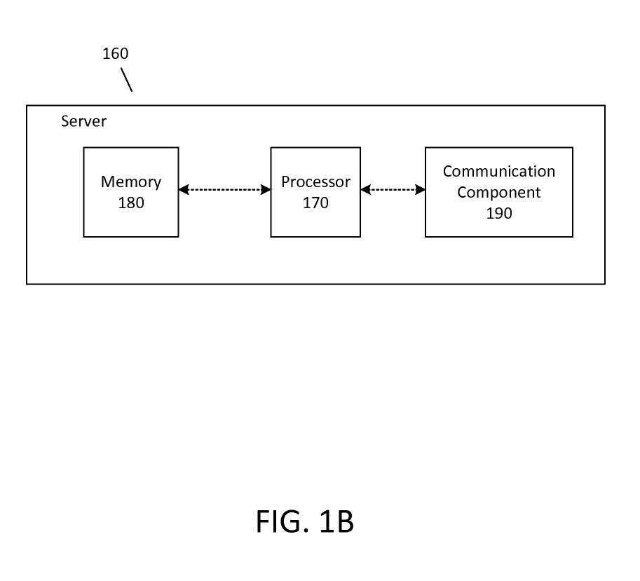

Referring now to FIG. 1A, a block diagram illustrating a client device according to one embodiment of the present invention is shown. Client device 100 comprises a processor 110. Client device 100 also comprises a memory 120, a display 130, a communication component 140, and one or more input devices 150, all in communication with processor 110. In some embodiments, the client device 100 may comprise a touch screen that acts as both a display 130 and an input device 150. In other embodiments, input devices 150 may include a keyboard, keypad, touchpad, scroll wheel, mouse, voice recognition system, motion detection system, and/or any other computer input device known to one having ordinary skill in the art.

Client device 100 is able to communicate over a network using a communication component 140. In the embodiment shown, communication component 140 is a Wi-Fi module. However, in embodiments of the present invention, communication component 140 may be any component that allows communication with a network. For example, communication component 140 may also be a module and antenna for communication with a cellular network. In another embodiment, communication component 140 may be an Ethernet or cellphone network card for connecting to a network. Client device 100 also comprises memory 120, which stores software program code that is executable by processor 110. For example, memory 120 may comprise random-access memory that stores program code for an operating system and interactive applications. For example, memory 120 may comprise software program code for Apple® iOS or Mac OS®, the Android™ operating system, Microsoft Windows® 7 or Windows® 8, Linux, or any other operating system, and any number of user applications that allow a user to make in-app purchases of virtual products, physical products, services, or to make charitable donations. For example, in one embodiment a client device 100 may be a computer with a web browser application that allows access to and execution of applications through webpages, such as games accessible through www.facebook.com (e.g., Zynga's Farmville®), wherein the applications allow purchases of virtual products, physical products, services, or making charitable donations from the application. In another embodiment, the client device may be a smart phone with a gaming application (e.g. Prestige Gaming's Slot Magic™, Dublin Dollars™, and Captain Cash applications; Zynga Poker®; Rovio's Angry Birds® series of applications) installed through which a user may make in-app purchases of virtual products, physical products, services, or may make a charitable donation.

FIG. 1B is a block diagram illustrating a server according to one embodiment of the present invention is shown. Server 160 comprises a processor 170. Server 160 also comprises a memory 180 and a communication component, both in communication with processor 170. In some embodiments, one or more displays and/or one or more input device may be connected to server 160. In other embodiments, the server 160 is accessed from a remote terminal across a network. Server 160 communicates over a network using a communication component 190. In the embodiment shown, communication component 190 is an Ethernet card. However, in embodiments of the present invention, communication component 190 may be any component that allows communication over a network. For example, communication component 190 may be a wireless networking device. Server 160 may communicate with client computers/devices and other servers (e.g. database server).

Server 160 also comprises memory 180 comprising software program code executable by processor 170. For example, memory 180 may comprise random-access memory and/or a hard disk that comprises software program code for an operating system and applications. For example, memory 180 may comprise software program code for Microsoft Windows Server®, a Linux operating system, a UNIX operating system, or any other operating system suitable for a server, any number of applications, and/or data. For example, in one embodiment server 160 may be a web server comprising web server software and data for serving static and/or dynamically created webpages. In another embodiment, the server 160 may be an application server comprising stored applications and software for distributing the applications. In still another embodiment, server 160 may be a dedicated database server comprising database software and stored data. Furthermore, server 160 may be any combination of a web server, application server, and/or database server.

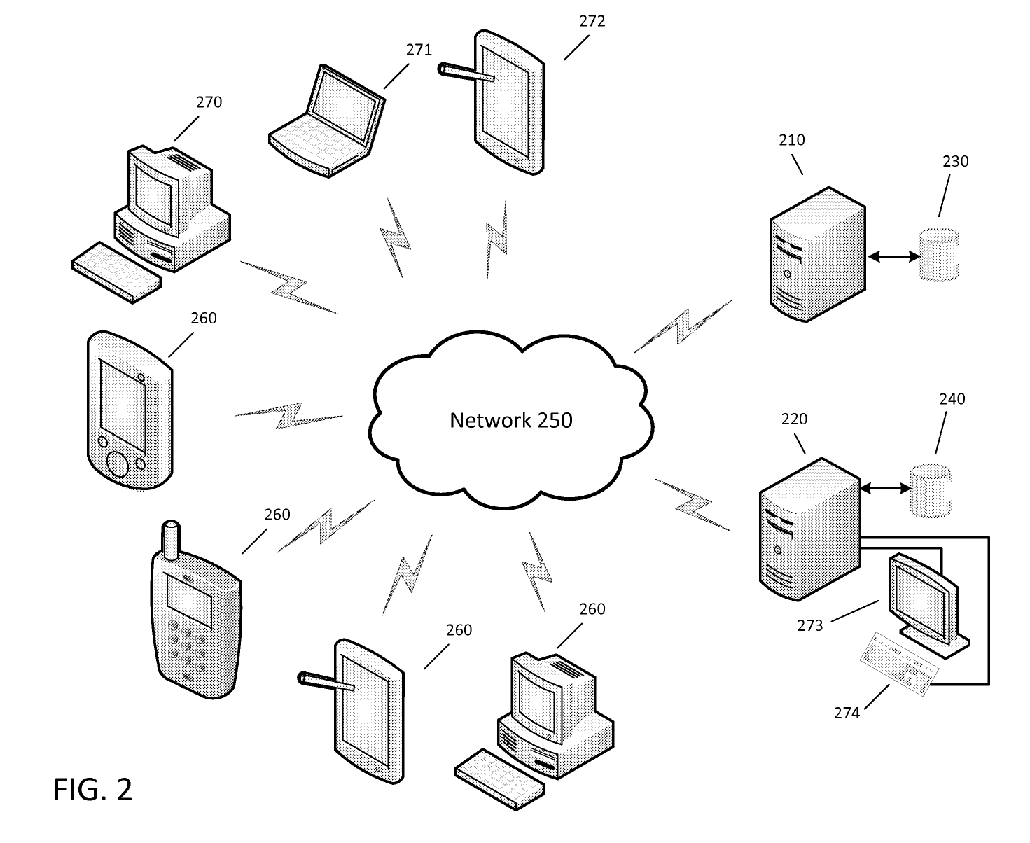

As described above, the client device of embodiments of the present invention is capable of network communication. FIG. 2 is a diagram illustrating a client-server network configuration according to one embodiment of the present invention. One or more client devices 260 communicate with servers, such as servers 210 and 220, over a network 250, such as the Internet, as shown in FIG. 2. A client device 260 may be an Apple iPhone®, an Apple® iPad®, an Android™ phone, an Android™ tablet computer, an Amazon Kindle®, a Barnes and Noble Nook®, a Blackberry®, a desktop computer, a laptop computer, a tablet computer, a PDA or any other client computing device known to those of skill in the art. In one embodiment, servers 210 and 220 respectively interface with one or more databases 230 and 240 to retrieve data needed to fulfill client requests. Databases 230 and 240 may be administered by dedicated database servers or may be housed and administered by servers 210 and 220, respectively. In one embodiment, one or more of the databases are relational MySQL® databases. In other embodiments, other known database types and technologies may be employed.

In one embodiment, server 210 is a server affiliated with an application marketplace for distributing applications for a particular operating system platform and for processing in-app purchases. For example, server 210 may be an Apple App Store server for Apple® iOS devices or a Google Play™ server for Android™ devices. In another embodiment, server 210 is a server for providing applications accessible through a web browser executing on a client device 260. A client device 260 may communicate with server 210 to purchase and/or download applications for execution on client devices 260. In another embodiment, server 210 may be a server affiliated with an application developer or seller of virtual products, physical products, and/or services, or a server affiliated with a non-profit organization (e.g. charity, school, etc.). For example, server 210 may be a Zynga® server that handles in-app purchases (e.g. poker chips and gold Zynga® tokens) for Zynga Poker® or a Rovio™ server that handles in-app purchases (e.g. the Mighty Eagle® power up item) for Angry Birds® applications.

In the embodiments described above, server 210 may be operable to communicate with client devices 260 to receive requests for and process in-app purchases. Server 210 is further configured to communicate information related to in-app purchases to a Sweepstakes Server 220 over network 250. In some embodiments, information related to in-app purchases for only select applications is transmitted to the Sweepstakes Server 220. In other embodiments, information related to in-app purchases for all applications is transmitted to the Sweepstakes Server 220.

Sweepstakes Server 220 comprises software program code for configuring and administering sweepstakes contests. In one embodiment, the Sweepstakes Server 220 may be configured to administer two or more sweepstakes contests at the same time. Sweepstakes Server 220 provides sweepstakes administration interfaces for creating and configuring sweepstakes contests. In one embodiment, the Sweepstakes Server 220 provides a web-based sweepstakes administration interface that facilitates sweepstakes contest creation and configuration through the use of a standard web browser on computing devices, such as desktop computer 270 and laptop computer 271, that are able to communicate with Sweepstakes Server 220 over a network 250. In another embodiment, Sweepstakes Server 220 may provide an interface (e.g. an application programming interface, one or more remote procedure calls, a sweepstakes administration protocol, or any other interface known by one having skill in the art) through which stand-alone applications on computing devices, such as tablet computer 272, in communication with Sweepstakes Server 220 over a network 250 may use to create and configure sweepstakes contests on Sweepstakes Server 220. In another embodiment, Sweepstakes Server 220 comprises one or more output devices (e.g. monitor 273), and one or more input devices (e.g. keyboard 274), for interfacing directly with Sweepstakes Server 220 create and configure sweepstakes contests. To prevent unauthorized access, Sweepstakes Server 220 may require authentication before allowing sweepstakes creation, configuration, and/or administrative activities to be performed. Authentication may be performed using any method known to one having ordinary skill in the art.

Database 240 is configured to store sweepstakes contest data and sweepstakes contestant data. At the time a sweepstakes contest is created, the creator may define a number of characteristics including preview, start, end, and reminder dates for the sweepstakes contest, total number of entries, quantity and nature or prizes to be awarded, one or more applications from which qualifying purchases or charitable donations may be made, a minimum purchase/donation amount in U.S. dollars, any other government-backed currency, or a virtual currency, and/or any other characteristics that would be useful for configuring a sweepstakes contest. The sweepstakes configuration is stored in database 240. Based on the sweepstakes configuration information, a finite number of sweepstakes entries are created, assigned a particular prize or designated as losing entries, and are stored in database 240. In one embodiment, each sweepstakes entry in the finite predetermined pool of sweepstakes entries has a unique identifier associated it (“sweepstakes entry ID”) that is also stored in database 240. The database record for each sweepstakes entry may be further configured to include a field for indicating whether the sweepstakes entry has been awarded, a field for associating the entry to a particular transaction, a field for associating the entry to a particular user, and any combination thereof. Database 240 may be further configured to store registered sweepstakes contestant information comprising contestants' names, addresses, email addresses, telephone numbers, account numbers, unique device identifiers, usernames, passwords, awarded sweepstakes entries, sweepstakes prize totals, sweepstakes prize redemption requests, leaderboard ranking, and/or whether the contestant has accepted the terms of service. In one embodiment, the Sweepstakes Server 220 is further configured to receive sweepstakes contestant registration information and to interface with a database, such as database 240, to create and maintain profiles of registered sweepstakes contestants. Each registered sweepstakes contestant may be assigned a unique account number, may choose a unique username during the registration process, or a combination thereof, which is then stored in database 240.

The Sweepstakes Server 220 is further configured to receive in-app purchase information. In one embodiment, the in-app purchase is a purchase of virtual products. In other embodiments, the in-app purchase may be for physical products or services, or may be a charitable donation. In one embodiment, an in-app purchase may be made through the use of known payments methods (e.g. credit card, debit card, electronic funds transfer from a bank account) for causing the transfer of U.S. dollars or another of government-backed currency to an account belonging to the seller. In another embodiment, an in-app purchase may be made using virtual currency that was previously purchased or otherwise obtained by the purchaser. The Sweepstakes Server 220 is further configured to process received in-app purchase information to determine whether an in-app purchase is eligible for the award of sweepstakes entries based on the configuration of the sweepstakes stored in database 240. In the event that Sweepstakes Server 220 determines that an in-app purchase is eligible for an award of one or more sweepstakes entries, Sweepstakes Server 220 is configured to determine the number of sweepstakes entries to be awarded, identify available sweepstakes entries by querying database 240, allocate the identified sweepstakes entries to a particular in-app purchase, store allocation information in database 240, and transmit sweepstakes entry notifications to client devices 260. In one embodiment, sweepstakes entry allocation information is stored by placing information that uniquely identifies a particular sweepstakes contestant (e.g. a username, account number, social security number, etc.) into a designated field in the allocated sweepstakes entry in database 240. In another embodiment, sweepstakes entry allocation information is stored by placing information that uniquely identifies a particular transaction (e.g. a transaction ID) into a designated field in the allocated sweepstakes entry record in database 240. In still another embodiment, sweepstakes entry allocation information is stored by setting a flag in the sweepstakes entry that indicates that the sweepstakes entry is no longer available and by placing the sweepstakes entry ID of the allocated sweepstakes entry into a list of awarded sweepstakes entries in a sweepstakes contestant's profile in database 240.

Sweepstakes Server 220 is configured to provide notifications, such as sweepstakes entry notifications, to a client device 260. In one embodiment, Sweepstakes Server 220 is configured to provide “push” notifications to client devices 260. In another embodiment, Sweepstakes Server 200 is configured to provide “pull” notifications in response to requests from client devices 260. In still another embodiment, Sweepstakes Server 220 is configured to provide both push and pull notifications.

Client devices 260 operate to receive notifications from Sweepstakes Server 220 and to relay the content of the notifications to the respective users. Notifications may include information about upcoming sweepstakes contests, information to remind a sweepstakes contestant about the start and/or end dates of a particular sweepstakes contest, sweepstakes entry information, and/or any other information related to a sweepstakes contest. For example, after a user completes an in-app purchase using a client device 260, the client device 260 may receive a push notification from the Sweepstakes Server 220 comprising sweepstakes entry information. In another embodiment, a client device 260 is configured to transmit a status request to Sweepstakes Server 220, thereby requesting Sweepstakes Server 220 to notify the client device 260 of sweepstakes entries awarded to the user of the client device 260. In response, Sweepstakes Server 220 transmits a pull notification to the client device 260 comprising sweepstakes entry information. In one embodiment, the sweepstakes entry information included with push and/or pull notifications comprises one or more sweepstakes entry IDs to identify the awarded sweepstakes entries.

In one embodiment, a client device 260 is configured to display a notice notifying the user that he/she has been awarded sweepstakes entries (a “sweepstakes entry notice”) immediately upon receiving the push/pull notification from the Sweepstakes Server 220. In another embodiment, a client device 260 may be configured to display a sweepstakes entry notice immediately upon receiving the push/pull notification if the application associated with the in-app purchase is open and in use. In still another embodiment, a client device 260 may be configured to display the sweepstakes entry notice when the user navigates to a particular screen of the application associated with the in-app purchase. For example, in one embodiment the sweepstakes entry notice is displayed when the user accesses a main menu of the application after the push/pull notification is received.

In one embodiment, a sweepstakes entry notice displayed by a client device 260 comprises a button or other known user interface element that a user may press or otherwise manipulate to transition to a sweepstakes results reveal screen to reveal the results of the one or more sweepstakes entries. In one embodiment, the sweepstakes entry information included in a push/pull notification comprises the number of entries awarded and one or more unique identifiers corresponding to awarded sweepstakes entries, but does not include sweepstakes results information. In this embodiment, the client device 260 is configured to communicate a sweepstakes results request seeking sweepstakes results information to Sweepstakes Server 220 upon a user manipulating the user interface to reveal the results of the sweepstakes entries. In one embodiment, the sweepstakes result request comprises one or more sweepstakes entry IDs identifying the sweepstakes entries for which results are requested. In other embodiments, a sweepstakes result request may comprise any information that may be used to identify the one or more awarded sweepstakes entries. In alternative embodiments, the sweepstakes result request may include a registered sweepstakes contestant's account number, unique username, unique device ID, or any other information that may be used to identify the sweepstakes contestant. Based on the information identifying the one or more awarded sweepstakes entries, the information identifying a sweepstakes contestant, or a combination thereof, Sweepstakes Server 220 collects the prize information and communicates the sweepstakes results information to the client device 260. In another embodiment, the sweepstakes results information is included in the push/pull notification transmitted to a client device 260 by Sweepstakes server 220 to provide sweepstakes entry information. In this case, there is no need for the client device 260 to separately request sweepstakes results information when a user manipulates the user interface to reveal the sweepstakes results on the client device 260.

In one embodiment, sweepstakes results information further comprises information indicating how sweepstakes results are to be revealed to the user. For example, sweepstakes results information may provide an interactive prize reveal interface with which a sweepstakes contestant interacts to reveal the sweepstakes results, a URL to a webpage for displaying the sweepstakes results, an image showing the sweepstakes results, or any other method known to one having ordinary skill in the art.

### Operation of an Illustrative Sweepstakes System

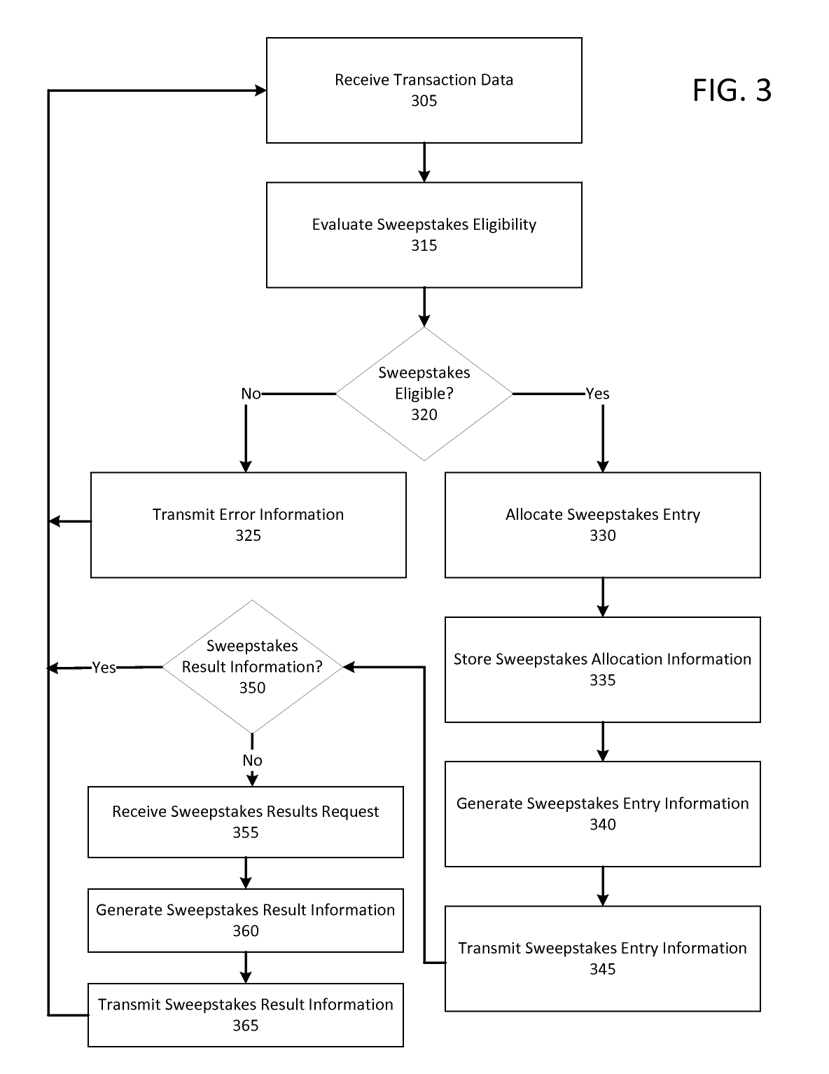

FIG. 3 is a flow diagram illustrating the operation of a server in communication with a client device according to embodiments of the present invention. In particular, FIG. 3 shows steps performed by a Sweepstakes Server to administer one or more sweepstakes contests including the allocation of sweepstakes entries for eligible purchases of products or charitable donations. To aid in understanding how each of the steps may be performed, the following description is provided in the context of the illustrative system shown in FIG. 2. However, embodiments of the present invention may be implemented in alternative embodiments.

Beginning at step 305, Sweepstakes Server 220 receives information from the server 210 related to an in-app purchase initiated by a user of a client device 260 (“in-app purchase information”). The in-app purchase information may comprise the name of the application from which the purchase was made, an unique identifier for identifying the application, a description of the product(s) purchased, a code identifying the product(s) purchased, a total dollar amount in U.S. dollars, any other government-backed currency, or a virtual currency paid for the purchase, geographic location of the purchaser, or any other information that may be used to determine sweepstakes eligibility.

At step 315, Sweepstakes Server 220 processes the in-app purchase information received from server 210 to determine whether the in-app purchase satisfies the configured requirements of any of the sweepstakes contests currently being administered by Sweepstakes Server 220. A sweepstakes contest maybe configured so that it requires in-app purchases to be made from a particular application or applications, a minimum purchase amount (in U.S. dollars, any other government-backed currency, or a virtual currency), purchase of particular products or product combinations, purchasers to be located within particular geographic boundaries, a minimum age to participate, or any other criteria that a sweepstakes creator would know to include. In one embodiment, sweepstakes eligibility criteria are stored in database 240. Upon receiving in-app purchase information, Sweepstakes Server 220 accesses and compares sweepstakes eligibility criteria to the in-app purchase information to determine whether the in-app purchase is eligible for an award of one or more sweepstakes entries.

If Sweepstakes Server 220 determines that the in-app purchase is not eligible to be awarded one or more sweepstakes entries, the method proceeds through decision point 320 to step 325. At step 325, the Sweepstakes Server 220 generates and transmits a message to the client device 260 indicating that the in-app purchase did not qualify for an award of one or more sweepstakes entries. In another embodiment, Sweepstakes Server 220 stores a rejection log of in-app purchases that failed to meet the criteria for receiving sweepstakes entries. After completion of an in-app purchase, the client device 260 sends an inquiry to Sweepstakes Server 220 inquiring whether sweepstakes entries were awarded for a particular the in-app purchase. Upon receiving the inquiry from a client device 260, Sweepstakes Server 220 may check the rejection log for the particular in-app purchase. When the Sweepstakes Server 220 locates the in-app purchase in the rejection log, Sweepstakes Server 220 transmits a message to the client device 260 indicating that the in-app purchase did not qualify for the award of one or more sweepstakes entries.

If the Sweepstakes Server 220 determines that the in-app purchase is eligible for one or more sweepstakes entries, the method proceeds through decision point 320 to step 330. At step 330, Sweepstakes Server 220 determines the number of sweepstakes entries to award, identifies available sweepstakes entries from a predetermined finite pool of sweepstakes entries in the database 240, and allocates identified sweepstakes entries to the eligible in-app purchase and/or the sweepstakes contestant for the eligible in-app purchase.

At step 335, sweepstakes entry allocation information is stored in the database 240. As described above, sweepstakes entry allocation information may stored by placing information that uniquely identifies a particular sweepstakes contestant (e.g. a username, account number, social security number, etc.) into a designated field in the allocated sweepstakes entry in the database 240, by placing information that uniquely identifies a particular transaction (e.g. a transaction ID) into a designated field in the allocated sweepstakes entry record in the database 240, by setting a flag in the sweepstakes entry that indicates that the sweepstakes entry is no longer available and by placing the sweepstakes entry ID of the allocated sweepstakes entry into a list of awarded sweepstakes entries in a sweepstakes contestant's profile in the database 240, or by any other method that one having ordinary skill in the art would know to use for storing sweepstakes entry allocation information in a database.

At step 340, Sweepstakes Server 220 generates sweepstakes entry information for transmission to the client device 260. In one embodiment, Sweepstakes Server 220 automatically generates sweepstakes entry information to be transmitted to a client device 260 (a “push” notification) upon allocating one or more sweepstakes entries to an eligible in-app purchase. In another embodiment, Sweepstakes Server 220 waits for an inquiry from a client device 260 and then generates the sweepstakes entry information to be sent to the client device 260 in response to the inquiry (a “pull” notification). In one embodiment, sweepstakes entry information comprises information retrieved from database 240 by Sweepstakes Server 220. In another embodiment, sweepstakes entry information may comprise sweepstakes entry IDs for each of the sweepstakes entries awarded. In still another embodiment, the sweepstakes entry information comprises information that uniquely identifies the sweepstakes contestant and/or the eligible in-app purchase for which the sweepstakes entries were awarded. In additional embodiments, sweepstakes entry information comprises sweepstakes entry IDs for each of the sweepstakes entries awarded, information that uniquely identifies the sweepstakes contestant and/or the eligible in-app purchase, and/or any other information useful for providing notification to a sweepstakes contestant and/or for subsequent communications with Sweepstakes Server 220 related to requesting sweepstakes results information or initiating redemption of sweepstakes prizes.

At step 345, the Sweepstakes Server 220 transmits the sweepstakes entry information to the client device 260 over the network 250. Sweepstakes entry information may be formatted into a particular data or message format for transmission to client devices 260. For example, Sweepstakes Server 220 and client devices 260 may comprise program code defining a common data structure for sweepstakes entry information, whereby Sweepstakes Server 220 may provide sweepstakes entry information and client devices 260 may understand and correctly extract sweepstakes entry information received from Sweepstakes Server 220.

In one embodiment, sweepstakes entry information comprises sweepstakes results information. If this is the case, the method proceeds through decision point 350 and returns to step 305 to receive information related to an in-app purchase. In another embodiment, the sweepstakes entry information comprises the number of entries awarded and information for identifying the one or more sweepstakes entries that are the subject of the notice (e.g. sweepstakes entry IDs), but does not include sweepstakes results information. In this embodiment, the method proceeds through decision point 350 to step 355. At step 355, Sweepstakes Server 220 receives a sweepstakes results request from the client device 260. In one embodiment, the sweepstakes results request comprises one or more sweepstakes entry IDs identifying the sweepstakes entries for which results are requested. In other embodiments, the sweepstakes results request comprises information that uniquely identifies the sweepstakes contestant and/or the eligible in-app purchase, or any other information that may be used by Sweepstakes Server 220 to identify sweepstakes entries for which result information is being requested.

At step 360, Sweepstakes Server 220 retrieves prize information from database 240 based on the sweepstakes entry IDs, a sweepstakes contestant account number, sweepstakes contestant username, in-app transaction ID, other information included in a sweepstakes results request useful for identifying sweepstakes entries, or a combination thereof. Sweepstakes Server 220 then retrieves prize information for each sweepstakes entry identified directly or indirectly by the sweepstakes results request from the database 240 and generates sweepstakes results information for transmission to the client device 260. At step 365, the Sweepstakes Server 260 sends the sweepstakes results information to client device 160 over the network 250.

As discussed in more detail above and below, sweepstakes results information, whether included in the sweepstakes entry information transmitted to a client device 260 at step 345 or separately transmitted at step 365 in response to a sweepstakes results request, comprises information identifying the prizes won by the sweepstakes contestant for the sweepstakes entries awarded for an eligible in-app purchase. In addition, the sweepstakes results information may include information indicating how sweepstakes prize results are to be revealed to the sweepstakes contestant.

### Illustrative Prize Reveal Screens

As discussed above, in some embodiments the sweepstakes results information sent to the client device 260 comprises information indicating how the sweepstakes results are to be revealed to a sweepstakes contestant. For example, sweepstakes results information transmitted by Sweepstakes Server 220 to a client device 260 may include custom images, animations, or interactive interfaces for revealing sweepstakes results. In another embodiment, the client device 260 comprises program code for revealing sweepstakes prize results. For example, an application residing on a client device 260 from which an in-app purchase is made, wherein the in-app purchase results in the award of one or more sweepstakes entries, may comprise program code that dictates how sweepstakes prize results are to be revealed. In such an embodiment, the client device receives sweepstakes results data from Sweepstakes Server 220 but reveals the results to the user according to the program code for revealing sweepstakes prize results.

In one embodiment, sweepstakes prize results are revealed through an interactive prize reveal interface. A sweepstakes contestant may interact with the interactive prize reveal interface to reveal the sweepstakes results. An interactive prize reveal interface advantageously provides the ability to reveal sweepstakes prize results in an entertaining, exciting, and/or engaging manner. As a result, sweepstakes contestants may decide to execute additional sweepstakes-eligible in-app purchases. In one embodiment, the interactive prize reveal interface is an interactive Flash animation. In other embodiments, other technologies, such as AJAX-based interfaces, known by those having ordinary skill in the art may be used.

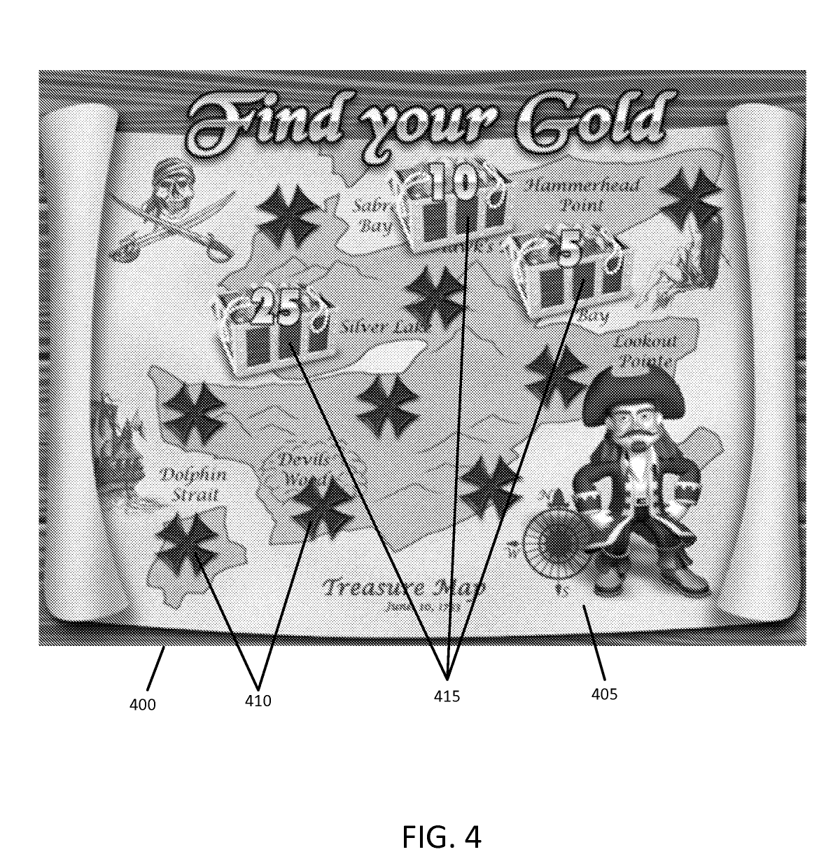

FIG. 4 illustrates an interactive prize reveal interface 400 according to one embodiment of the present invention. The interactive prize reveal interface 400 comprises a pirate treasure map background 405 with a plurality of X symbols 410. A sweepstakes contestant may tap or click one or more of the X symbols 410 to reveal treasure chests 415, each displaying a prize amount. In one embodiment, the sum total of prize values revealed by selecting all of the X symbols 410 equals the amount awarded for a group of one or more sweepstakes entries. In another embodiment, the total amount awarded for a group of sweepstakes entries is revealed by selecting a subset of the X symbols 410 displayed by the interactive prize reveal interface 400. In still another embodiment, the entire prize amount may be revealed when a predetermined X symbol 410 is selected and preceding selection of other X symbols 410 would provide an indication of a zero value (e.g. displaying an empty hole in the ground).

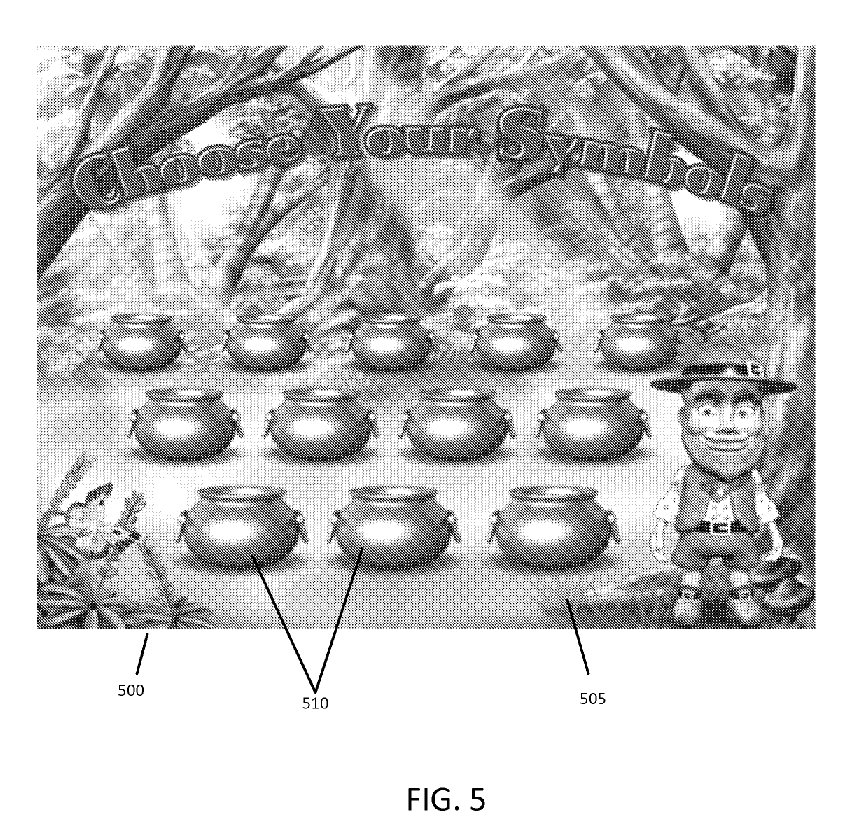

FIG. 5 illustrates an interactive prize reveal interface 500 according to one embodiment of the present invention. The interactive prize reveal interface 500 comprises a forest clearing background 505 with a plurality of pots 510. A sweepstakes contestant may tap or click one or more of the pots 510 to reveal a prize amount. In one embodiment, the sum total of prize values revealed by selecting all of the pots 510 equals the amount awarded for a group of one or more sweepstakes entries. In another embodiment, the total amount awarded for a group of sweepstakes entries is revealed by selecting a subset of the pots 510 displayed by the interactive prize reveal interface 500. In still another embodiment, the entire prize amount may be revealed when a predetermined pot 510 is selected and preceding selection of other pots 510 would provide an indication of a zero value (e.g. displaying the empty interior of the pot 510).

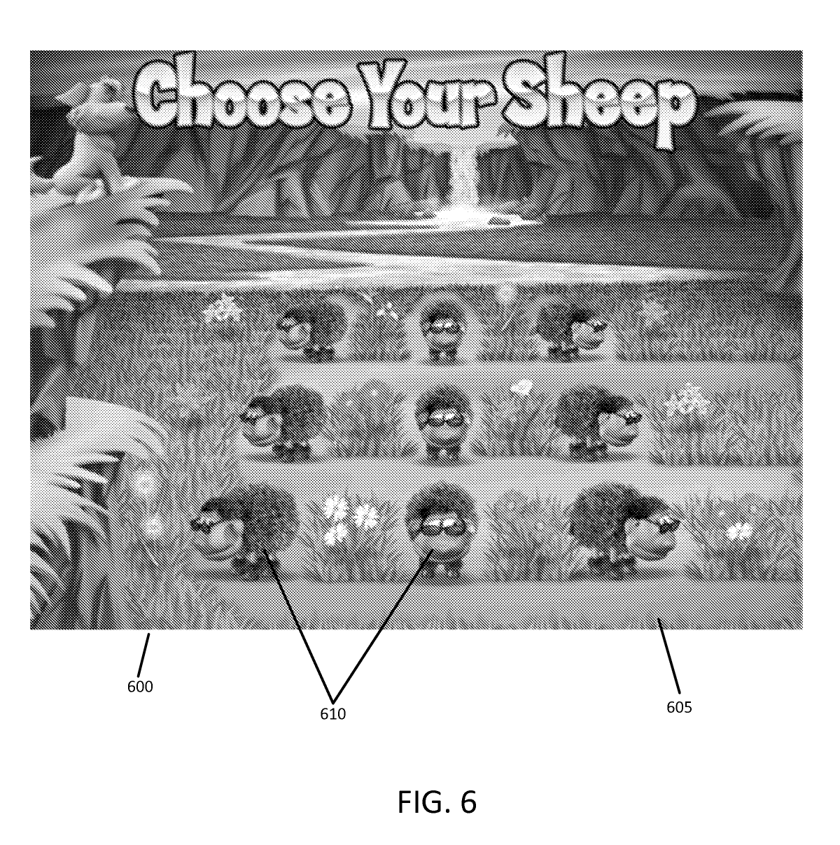

FIG. 6 illustrates an interactive prize reveal interface 600 according to one embodiment of the present invention. The interactive prize reveal interface 600 comprises a prairie field background 605 with a plurality of sheep 610. A sweepstakes contestant may tap or click one or more of the sheep 610 to reveal a prize amount. In one embodiment, the sum total of prize values revealed by selecting all of the sheep 610 equals the amount awarded for a group of one or more sweepstakes entries. In another embodiment, the total amount awarded for a group of sweepstakes entries is revealed by selecting a subset of the sheep 610 displayed by the interactive prize reveal interface 600. In still another embodiment, the entire prize amount may be revealed when a predetermined sheep 610 is selected and preceding selection of other sheep 610 would provide an indication of a zero value (e.g. displaying a “0” on a shaved side of a sheep 610).

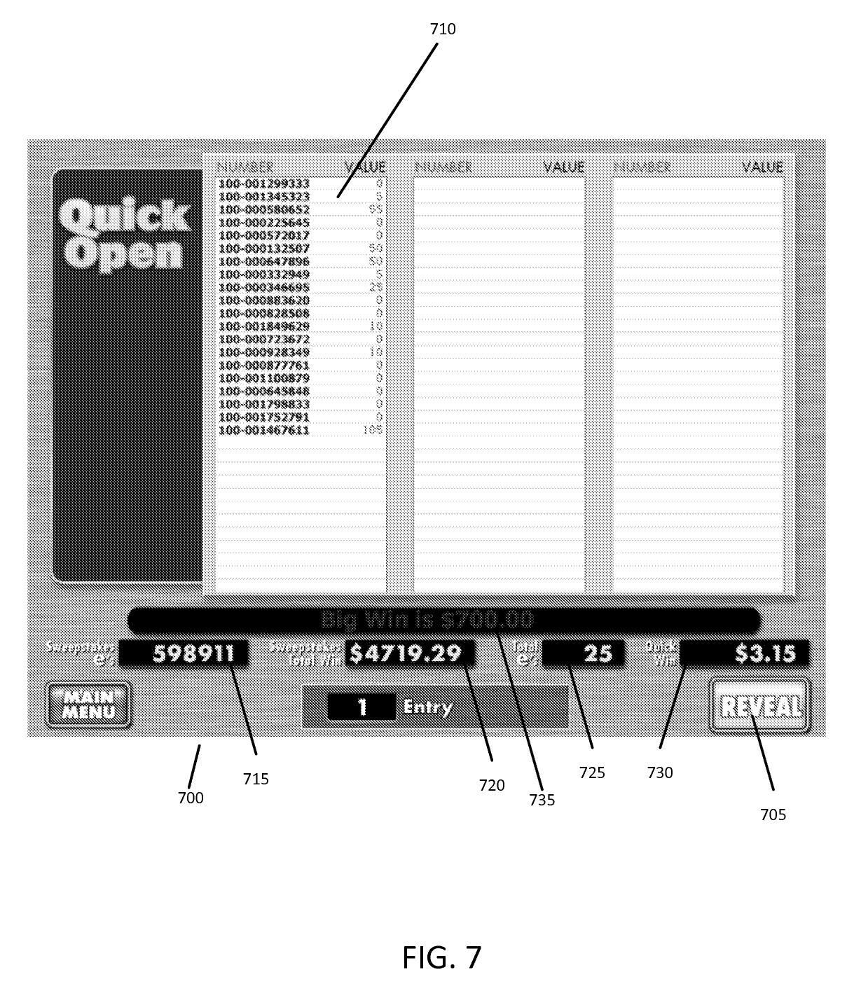

FIG. 7 illustrates an interactive prize reveal interface 700 according to one embodiment of the present invention. The interactive prize reveal interface 700 comprises a reveal button 705, a sweepstakes results display area 710, a lifetime sweepstakes entries display area 715, a lifetime sweepstakes winnings display area 720, a total sweepstakes entries display area 725, a total winning display area 730, and a largest win display area 735. The lifetime sweepstakes entries display area 715 and the lifetime sweepstakes winnings display area 720 respectively display the total number of entries and total winnings for a sweepstakes contestant over the lifetime of the contestant's sweepstakes account. The largest win display area 735 displays the sweepstakes contestant's largest single sweepstakes award over the lifetime of the sweepstakes contestant's account. The reveal button 705 may be pressed to reveal the results of pending yet-to-be revealed sweepstakes entries. Upon pressing the reveal button 705, the results of the yet-to-be revealed sweepstakes entries are individually displayed in sweepstakes results display area 710. As shown, sweepstakes results display area 710 lists an identification number for each sweepstakes entry and the prize amount awarded for each entry. The total sweepstakes entries display area 725 displays the number of sweepstakes entries presently revealed and the total winning display area 730 displays the total amount of the awarded prizes revealed sweepstakes results display area 710.

The illustrative interactive prize reveal interfaces of FIGS. 4-7 are intended to assist with the understanding of the present invention and do not limit the present invention in any way. Additional interactive prize reveal interfaces and related techniques may be used. For example, an additional interactive prize reveal interface may comprise displaying a gold pan full of dirt and rocks and, in response to a sweepstakes contestant moving her client device in a manner similar to panning for gold, revealing gold nuggets in the pan, wherein each nugget displays a prize value. Another exemplary interactive prize reveal interface may comprise a large prize wheel that a sweepstakes contestant may spin by dragging his finger over the wheel. When the prize wheel finishes spinning, the prize wheel displays the awarded prize amount. Accordingly, the present invention contemplates any interactive prize reveal interface that one having ordinary skill in the art would use to reveal awarded sweepstakes prize amounts.

In other embodiments various methods for revealing prize results may be used. For example, sweepstakes entry information/sweepstakes results information may comprise one or more media files for revealing prize results including images (e.g. JPEG, PNG, and BMP images), animations (e.g. animated GIF files, Flash animations), video (e.g. MPEG, WMV, and AVI files), and any other media file type known to one having ordinary skill in the art.

In some embodiments sweepstakes entry information/sweepstakes results information comprises a uniform resource locator (URL) for a webpage for displaying the sweepstakes results. When a sweepstakes contestant chooses to view sweepstakes results for awarded sweepstakes entries, the URL is used to retrieve and display a webpage for displaying sweepstakes results on a client device. In one embodiment a webpage for displaying sweepstakes results comprises an image or any other media file type, such as those described above, indicating the sweepstakes results. In another embodiment, a webpage for displaying sweepstakes results comprises an interactive prize reveal interface for revealing the sweepstakes prize results. For example, the illustrative interactive prize reveal interfaces shown in FIGS. 4-6 and described above may be delivered in a webpage for displaying sweepstakes results. The present invention contemplates webpages for displaying sweepstakes results comprising any elements or methods for displaying information known by one having ordinary skill in the art.

### Creating and Customizing a Sweepstakes Contest

In one embodiment of the present invention, sweepstakes administration interfaces are provided for creation, configuration, scheduling, and maintenance of sweepstakes contests. To aid in understanding the various sweepstakes administration interfaces for, the following description is provided in the context of the illustrative system shown in FIG. 2. However, embodiments of the present invention may be implemented in alternative embodiments.

In one embodiment, one or more sweepstakes administration interfaces are applications executing on a Sweepstakes Server 220 accessible through input and output devices (e.g. monitor 273, keyboard 274, and any other known input and/or output devices including a mouse, a touchscreen, etc.) connected to the Sweepstakes Server 220. In another embodiment, one or more sweepstakes administration interfaces are web-based interfaces accessed through a web browser executing on a computing device (e.g. desktop computer 270, laptop computer 271, or any other computer device having a web browser) that is capable of communication across network 250. In one embodiment, a web-based sweepstakes administration interface is served up by a web server in communication with Sweepstakes Server 220. In another embodiment, Sweepstakes Server 220 functions as a web server and serves up a web-based sweepstakes administration interface. In still another embodiment, a sweepstakes administration interface is an application executing on a computing device (e.g. tablet computer 272) in communication with Sweepstakes Server 220. For example, the sweepstakes administration interface may be an iOS application executing on an iPad or an iPhone, an Android application executing on an Android phone, or a Windows application executing on a Windows-based desktop, laptop, or tablet computer. In one embodiment, at least two types of sweepstakes administration interfaces are provided. For example, a web-based sweepstakes administration interface accessible through a web browser and a stand-alone sweepstakes administration application may be provided, thereby allowing a sweepstakes administrator to configure a sweepstakes contest on Sweepstakes Server 220 through a web browser executing on laptop computer 271 and/or from a stand-alone sweepstakes administration application executing on tablet computer 272.

When a sweepstakes administrator or similar user creates, configures, or performs administrative tasks using a sweepstakes administration interface, a Sweepstakes Server 220 communicates with sweepstakes database 240 to add, update or delete data and/or to configure the structure of the data storage in database 240.

A sweepstakes administration interface of the present invention allows a sweepstakes administrator or similar user to configure details for a sweepstakes contest. For example, a sweepstakes administration interface of the present invention provides user interface components for configuring a total number of sweepstakes entries, total prize pool, distribution of prizes among the sweepstakes entries, sweepstakes schedule, eligible in-app purchase criteria (e.g. eligible applications, particular products/charitable donations, minimum purchase/donation amounts (in U.S. dollars, any other government-backed currency, or a virtual currency), and/or any other in-app purchase criteria), eligible sweepstakes contestant criteria (e.g. employee family member restrictions, and/or employee restrictions, residency requirements, and/or any other sweepstakes contestant criteria). In one embodiment, a sweepstakes administration interface allows a user to add and/or edit fields for data records in a sweepstakes database.

In one embodiment, a sweepstakes administration interface of the present invention provides interfaces for a sweepstakes administrator or similar user to perform sweepstakes management tasks. For example, a sweepstakes administration interface may provide interfaces for managing the types and frequency of notices sent to client devices, prize redemption, display of leaderboards, terms of service requirements, and blacklisting of sweepstakes contestants.

In one embodiment, a sweepstakes administration interface comprises a redemption management interface. A redemption management interface provides tools related to redemption of awarded sweepstakes prizes. In one embodiment, a redemption management interface displays pending redemption requests sortable by redemption request date, prize amount, or by any other data associated with the redemption requests. In another embodiment, a redemption management interface provides an option for exporting redemption request data as a text document, an Excel® file, a CSV file, or any other file type known by one having skill in the art.

In one embodiment, a sweepstakes administration interface comprises a leaderboard management interface for managing a list of the top winning sweepstakes contestants. For example, a redemption management interface may allow a user to modify data in database 240 including resetting a leaderboard, creating additional leaderboards (e.g. one each for top daily, weekly, and monthly winners), removing sweepstakes contestants from the list, and modifying sweepstakes contestant rankings.

In one embodiment, a sweepstakes administration interface comprises a terms of service (“TOS”) management interface for managing terms of service requirements for each sweepstakes contest. For example, a TOS management interface may allow a user to configure a sweepstakes to require all sweepstakes contestants to accept initial and/or revised terms of service before they can participate. In one embodiment, the TOS management interface allows a sweepstakes administrator to view a list of sweepstakes contestants who either have or have not accepted the most recent terms of service, and to add/remove sweepstakes contestants from either list. In one embodiment, adding or removing a sweepstakes contestant from the blacklist involves setting or unsetting a flag within the sweepstakes contestant's profile in the sweepstakes database 240. In another embodiment, a blacklist comprising [Unique user ID] is maintained in the sweepstakes database 240.

In one embodiment, a sweepstakes administration interface comprises a blacklist management interface for managing a list of sweepstakes contestants known to have or suspected of cheating to prevent their further participation in a sweepstakes contest. In one embodiment, the blacklist management interface allows a sweepstakes administrator to view a list of blacklisted sweepstakes contestants, search the blacklist for a particular sweepstakes contestant, and to add/remove a sweepstakes contestant from the blacklist. In one embodiment, adding or removing a sweepstakes contestant from the blacklist involves setting or unsetting a flag within the sweepstakes contestant's profile in the sweepstakes database. In another embodiment, a blacklist comprising information identifying sweepstakes contestants (e.g. unique sweepstakes contestant ID, social security number, email address, username) is maintained in the sweepstakes database.

To provide one or more of the interfaces described above, a sweepstakes administration interface may comprise any known user interface components that one of ordinary skill in the art would know to use to create a user interface for creating and configuring a sweepstakes contest. For example, pull-down menus, radio buttons, text fields, check boxes, data selection calendars, and/or any other known user interface component may be used.

### Sweepstakes Website Services

In one embodiment, sweepstakes website is provided to support the administration of one or more sweepstakes contests. The sweepstakes website may be provided by Sweepstakes Server 220 or by a separate web server in communication with Sweepstakes Server 220. The sweepstakes website may provide any number of supporting services including serving webpages comprising a prize redemption forms for sweepstakes contestants to complete in order to redeem awarded prizes, serving webpages displaying terms of service and providing an interface for a sweepstakes contestant to accept or decline the terms of service, and serving webpages displaying leaderboards of the top winners for current and/or completed sweepstakes contests.

The foregoing examples are provided for illustrative purposes only. The present invention is not limited to these exemplary embodiments.

### General

While the methods and systems herein are described in terms of software executing on various machines, the methods and systems may also be implemented as specifically-configured hardware, such as a field-programmable gate array (FPGA) specifically to execute the various methods. For example, embodiments can be implemented in digital electronic circuitry, or in computer hardware, firmware, software, or in a combination of thereof. In one embodiment, a device may comprise a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

Reference herein to “one embodiment” or “an embodiment” means that a particular feature, structure, operation, or other characteristic described in connection with the embodiment may be included in at least one implementation of the invention. The invention is not restricted to the particular embodiments described as such. The appearance of the phrase “in one embodiment” or “in an embodiment” in various places in the specification does not necessarily refer to the same embodiment. Any particular feature, structure, operation, or other characteristic described in this specification in relation to “one embodiment” may be combined with other features, structures, operations, or other characteristics described in respect of any other embodiment.

1. A method comprising:
receiving a first transaction information from a first computing device over a network;
comparing the first transaction information to a sweepstakes criteria using a sweepstakes engine to determine whether the transaction is sweepstakes eligible;
allocating an available sweepstakes entry if the transaction is sweepstakes eligible;
storing sweepstakes allocation information on a database server;
generating sweepstakes entry information; and
transmitting the sweepstakes entry information to a second computing device.

2. The method of claim 1, wherein the first computing device comprises a server not affiliated with a provider of the sweepstakes entry.

3. The method of claim 1, wherein the available sweepstakes entry is allocated from a predetermined finite pool of sweepstakes entries.

4. The method of claim 1, wherein the available sweepstakes entry comprises a plurality of available sweepstakes entries.

5. The method of claim 1, wherein the transaction is associated with a purchase of a virtual product.

6. The method of claim 1, wherein the transaction is associated with a charitable donation.

7. The method of claim 1, further comprising:
receiving a sweepstakes entry request from the second computing device.

8. The method of claim 1, wherein the first computing device and the second computing device are the same computing device.

9. The method of claim 1, wherein the sweepstakes entry information comprises sweepstakes results information.

10. The method of claim 9, wherein the sweepstakes results information comprises an address of a webpage for displaying sweepstakes results for the sweepstakes entry.

11. The method of claim 9, wherein the sweepstakes results information comprises a graphical animation for displaying sweepstakes results for the sweepstakes entry.

12. The method of claim 9, wherein the sweepstakes results information comprises an interactive interface for revealing sweepstakes results for the sweepstakes entry.

13. The method of claim 1, further comprising:
receiving a sweepstakes result request associated with the sweepstakes entry; and
transmitting sweepstakes results information in response to receiving the sweepstakes result request.

14. The method of claim 13, wherein the sweepstakes results information comprises an address of a webpage for displaying sweepstakes results for the sweepstakes entry.

15. The method of claim 13, wherein the sweepstakes results information comprises a graphical animation for displaying sweepstakes results for the sweepstakes entry.

16. The method of claim 13, wherein the sweepstakes results information comprises an interactive interface for revealing sweepstakes results for the sweepstakes entry.

17. A computer readable medium comprising software program code stored on a tangible medium, the software program code executable by a processor to:
receive transaction information from a first computing device over a network;
compare the transaction information to a sweepstakes criteria using a sweepstakes engine to determine whether the transaction is sweepstakes eligible;
allocate an available sweepstakes entry if the transaction is sweepstakes eligible;
store sweepstakes allocation information on a database server;
generate sweepstakes entry information; and
transmit the sweepstakes entry information to a second computing device.

18. The computer readable medium of claim 17, wherein the first computing device comprises a server not affiliated with a provider of the sweepstakes entry.

19. The computer readable medium of claim 17, wherein the available sweepstakes entry is allocated from a predetermined finite pool of sweepstakes entries.

20. The computer readable medium of claim 17, wherein the available sweepstakes entry comprises a plurality of available sweepstakes entries.

21. The computer readable medium of claim 17, wherein the transaction is associated with a purchase of a virtual product.

22. The computer readable medium of claim 17, wherein the transaction is associated with a charitable donation.

23. The computer readable medium of claim 17, further comprising software program code stored on a tangible medium, the software program code executable by a processor to:
receive a sweepstakes entry request from the second computing device,

24. The computer readable medium of claim 17, wherein the first computing device and the second computing device are the same computing device.

25. The computer readable medium of claim 17, wherein the sweepstakes entry information comprises sweepstakes results information.

26. The computer readable medium of claim 25, wherein the sweepstakes results information comprises an address of a webpage for displaying sweepstakes results for the sweepstakes entry.

27. The computer readable medium of claim 25, wherein the sweepstakes results information comprises a graphical animation for displaying sweepstakes results for the sweepstakes entry.

28. The computer readable medium of claim 25, wherein the sweepstakes results information comprises an interactive interface for revealing sweepstakes results for the sweepstakes entry.

29. The computer readable medium of claim 17, further comprising software program code stored on a tangible medium, the software program code executable by a processor to:
receive a sweepstakes result request associated with the sweepstakes entry; and
transmit sweepstakes results information in response to receiving the sweepstakes result request.

30. The computer readable medium of claim 29, wherein the sweepstakes results information comprises an address of a webpage for displaying sweepstakes results for the sweepstakes entry.

31. The computer readable medium of claim 29, wherein the sweepstakes results information comprises a graphical animation for displaying sweepstakes results for the sweepstakes entry.

32. The computer readable medium of claim 29, wherein the sweepstakes results information comprises an interactive interface for revealing sweepstakes results for the sweepstakes entry.

33. A sweepstakes system comprising:
a processor; and
a memory in communication with the processor, the memory comprising computer program code executable by the processor to:
receive transaction information from a first computing device over a network;
compare the transaction information to a sweepstakes criteria using a sweepstakes engine to determine whether the transaction is sweepstakes eligible;
allocate an available sweepstakes entry if the transaction is sweepstakes eligible;
store sweepstakes allocation information on a database server;
generate sweepstakes entry information; and
transmit the sweepstakes entry information to a second computing device.

34. The sweepstakes system of claim 33, wherein the remote computing device comprises a server not affiliated with a provider of the sweepstakes entry.

35. The sweepstakes system of claim 33, wherein the available sweepstakes entry is allocated from a predetermined finite pool of sweepstakes entries.

36. The sweepstakes system of claim 33, wherein the available sweepstakes entry comprises a plurality of available sweepstakes entries.

37. The sweepstakes system of claim 33, wherein the transaction is associated with a purchase of a virtual product.

38. The sweepstakes system of claim 33, wherein the transaction is associated with a charitable donation.

39. The sweepstakes system of claim 33, further comprises computer program code executable by the processor to:
receiving a sweepstakes entry request from the client computing device,

40. The sweepstakes system of claim 33, wherein the first computing device and the second computing device are the same computing device.

41. The sweepstakes system of claim 33, wherein the sweepstakes entry information comprises sweepstakes results information.

42. The sweepstakes system of claim 41, wherein the sweepstakes results information comprises an address of a webpage for displaying sweepstakes results for the sweepstakes entry.

43. The sweepstakes system of claim 41, wherein the sweepstakes results information comprises a graphical animation for displaying sweepstakes results for the sweepstakes entry.

44. The sweepstakes system of claim 41, wherein the sweepstakes results information comprises an interactive interface for revealing sweepstakes results for the sweepstakes entry.

45. The sweepstakes system of claim 33, wherein the memory further comprises computer program code executable by the processor to:
receive a sweepstakes result request associated with the sweepstakes entry; and
transmit sweepstakes results information in response to receiving the sweepstakes result request.

46. The sweepstakes system of claim 45, wherein the sweepstakes results information comprises an address of a webpage for displaying sweepstakes results for the sweepstakes entry.

47. The sweepstakes system of claim 45, wherein the sweepstakes results information comprises a graphical animation for displaying sweepstakes results for the sweepstakes entry.

48. The sweepstakes system of claim 45, wherein the sweepstakes results information comprises an interactive interface for revealing sweepstakes results for the sweepstakes entry.
